(19) United States
(12) Patent Application Publication
(10) Pub. No.: US 2005/0044236 A1
(43) Pub. Date: Feb. 24, 2005

(54) Method and apparatus for transmitting keyboard/video/mouse data to and from digital video appliances

(76) Inventor: David Stafford, Huntsville, AL (US)

Correspondence Address: Davidson Berquist Klima & Jackson LLP;Suite 920, 4501 N. Fairfax Drive, Arlington, VA, 22203, US

(21) Appl. No.: 10/912,056

(22) Filed: Aug. 6, 2004

Related U.S. Application Data
(60) Provisional application No. 60/492,744, filed on Aug. 6, 2003.

(51) Int. Cl. G06F 15/16

(52) U.S. Cl. 709/227; 709/231

(57) ABSTRACT

A method of exchanging keyboard/video/mouse data between a client work station and a digital video appliance connected through a general purpose network is disclosed. A protocol for exchanging this data includes the establishment of a secure sockets layer (SSL) connection for the transmission of all data other than the video data. The present protocol also establishes a non-secure video session connection across the same general purpose network for transmitting the digitized video from the digital video appliance to the client work station. The protocol also provides for the compression of the digitized video to reduce the band width required to transit the video signals.

This application claims priority from U.S. Provisional Application Ser. No. 60/492,744, filed Aug. 6, 2003, the entire contents of which are incorporated herein by reference.

### FIELD OF THE INVENTION

This application relates to the exchange of keyboard/video/mouse (KVM) data and video data between a client work station and a digital video KVM network appliance across a general purpose network.

### BACKGROUND

In traditional keyboard/video/mouse (KVM) switching systems, a user workstation is connected to a KVM switch using a dedicated set of interconnecting cables and signal lines. The KVM switch in turn is generally connected to a plurality of remote computers or servers using a similar set of dedicated cables connecting the servers to the KVM switch. In this type of KVM system, there is little concern for the security of the data transmitted between the client and the servers because the interconnecting network through which the data travels is a dedicated and generally proprietary system. In other words, only those users authorized to access the user work stations, and thereby access the KVM switching system, have access to the data being exchanged between the servers and the work stations.

With the advent of network-based KVM switching systems, there is a need to secure the KVM data that is exchanged between the work station and the KVM switch. This is because in a network-based KVM switching system, the KVM data is exchanged over a general purpose network which may be used by a large number of users. Such networks may include local area networks (LANS), wide area networks (WANS), the Internet, any combination of the foregoing, and any other type of general purpose of proprietary networks.

When communicating with a digital video appliance across a network such as the foregoing, it is necessary to transport the video data corresponding to the video being output from a server connected to the digital video appliance across the network. This means that there must be some way to digitize the analog video signals received from a server and packetize, and/or compress those video signals so that they can be transmitted across the network.

### SUMMARY

A video session protocol is now described that relays KVM data to and from digital video appliances across a network. Digital video appliances can include, for example, the DS 1800 and the DSR products sold by Avocent Corporation of Huntsville, Ala. These digital video appliances are also referred to, or described as, network-based KVM switches. A network-based KVM switch is connected to a plurality of computer servers. The KVM switch receives keyboard, video, and mouse data from each of the servers and reformats that data for transmission across a general purpose network. A client work station on the general purpose network receives the digitized KVM data and applies the keyboard, video, and mouse data to the appropriate device. The client work station also oversees keyboard and mouse input from a user, reformats that keyboard and mouse data for transmission across the general purpose network to the network-based KVM switch. The KVM switch receives the keyboard and mouse data, reformats it into a format that can be utilized by the server, and transmits that data to the appropriate server. The user of the client work station determines which server connected to the KVM switch the user wishes to communicate with, and/or control. The present invention describes a protocol for exchanging this KVM data between the client work station and one of the network-based KVM switches.

In order for a client work station to access a KVM switch target device, the client first establishes a video session protocol viewing session with the digital video appliance. When a client initiates a viewing session with an appliance, the client establishes a TCP secure sockets layer (SSL) connection and a non-secure TCP connection with the appliance. The secure sockets layer connection is made using a predefined TCP port number. A non-secure connection is made using a second predefined TCP port number. Preferably, all communication (except the video) occurs over the SSL connection. SSL implements industry standards for encryption using Transport Layer Security version 1 (TLSv1). Data over this SSL connection uses the following: DES, 3 DES, or 128-byte (RC 4-like) encryption algorithms and the anonymous Diffie-Hellman key exchange.

The digital video appliance listens on the predefined port number for the SSL connection request that will be initiated by the client. Once the digital video appliance has accepted an incoming connection request, it passes the session on, for further processing, and continues to listen on the same predefined port number in order to accept another connection request.

Once a successful SSL connection has been established, the client initiates a Login Request to the digital video appliance. This Login Request contains the user credentials (e.g., user name and password) to be used during this viewing session, as well as the ID of the selected target device. The digital video appliance can verify that the user name and password are valid for the selected target device.

Once the login has successfully been completed, other video session protocol messages may be issued by the client. Immediately following a successful login via the SSL connection, an appliance will accept a video session protocol video connection from the client on the second predefined port number. Once both of these connections have been established, the KVM session establishment procedure is complete.

If the SSL connection or the video data connection is broken at any time, the digital video appliance considers the client logged out and both TCP connections are terminated.

### BRIEF DESCRIPTION OF THE DRAWINGS

The invention will be more fully understood from the following detailed description, taken in conjunction with the accompanying in which:

FIG. 1 illustrates a networked application of the video session protocol.

FIG. 2 shows the packet format for a Secure Sockets Layers session message according to a preferred embodiment of the present invention.

FIG. 3 shows the message format of a video session message according to the preferred embodiment of the present invention.

FIG. 4 shows an exemplary SSL session message in accordance with the present invention.

FIG. 5 shows the initial dialog that occurs between the client and a digital video appliance when the display resolution is accepted without change in accordance with the present invention.

FIG. 6 shows the initial dialog that occurs between a client and a digital video appliance when the display resolution is adjusted before video transmission begins in accordance with the present invention.

### DESCRIPTION OF ONE OR MORE PREFERRED EMBODIMENTS

When a user of a client work station wishes to establish a communication session with a digital video appliance, such as network-based KVM switches, the client and digital appliance must communicate using as predefined protocol. The present video session protocol permits the exchange of keyboard, video and mouse data between such a digital video appliance and a client work station.

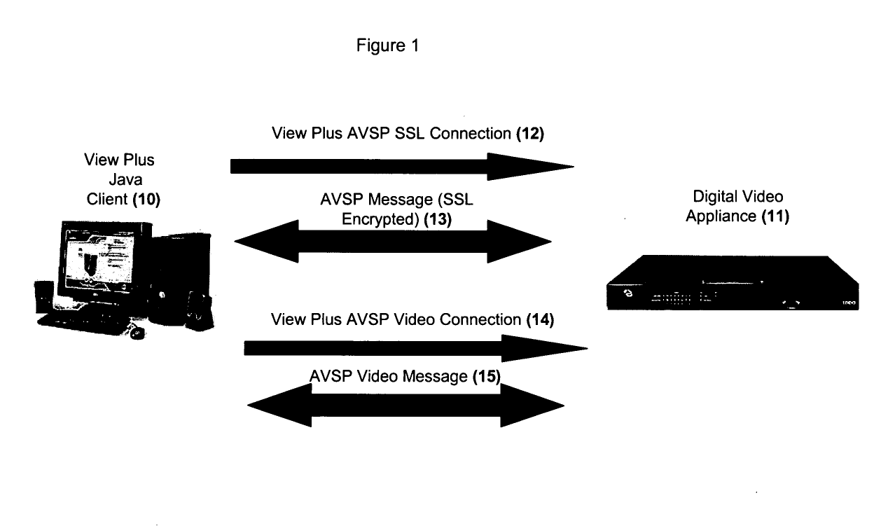

Referring to FIG. 1, in order for a client work station to access a target device such as a digital video appliance, it first establishes a video session protocol viewing session with the digital video appliance. Client 10 establishes such a connection by establishing a TCP Secure Sockets Layer (SSL) connection 12 and a non-secure TCP connection 14 with the appliance. Preferably, all communication (except video) occurs over the SSL connection 12. All data over this SSL connection uses the following encryption algorithms: DES, 3DES, or 128-BYTE (RC4-LIKE) encryption algorithms and the anonymous Diffie-Hellman key exchange. Digital video appliance 11 listens on a predefined port for the SSL connection request that will be initiated by client 10. Once the digital video appliance 11 has accepted an incoming connection request, it passes the session on for further processing to perform the functions that occur after session establishment. The digital video appliance 11 then listens again on the port in order to accept another connection request.

Once a successful SSL connection 12 has been established, client 10 initiates a login request to digital video appliance 11. This login request can contain the user credentials (e.g., user name and password) to be used during this viewing session, as well as the ID of the selected target device or server. Digital video appliance 11 verifies that the user name and password are valid for the selected target device.

Once the login has been successfully completed, other video session protocol messages may be issued by client 10. Immediately following a successful login via SSL connection 12, appliance 11 will accept a video session protocol video connection 14 from the client 10 on a second predefined port number. Once both of these connections 12 and 14 are established, the KVM session establishment procedure is complete. At that point, video session protocol SSL messages 13 maybe be exchanged between the client 10 and in the appliance 11. Similarly, video session protocol video messages 15 may be exchanged between client 10 and appliance 11.

If the SSL connection 12 or the video data connection 14 are broken, appliance 11 considers the client logged out and both TCP connections are terminated.

FIG. 2 shows the format of an SSL session message. Row 101 identifies this as an SSL session message. Row 102 identifies the first portion of the SSL session message as the message header and the second portion of the message as the message payload. Row 103 identifies the contents of the message header and message payload portions of the SSL session message. The message payload portion of the SSL session message contains the data associated with the particular message. The message header identifies the particular SSL session message by message type. The message header begins with a “start of header” field. This “start of header” field is 4 bytes long and contains a unique data value or pattern that is used to start all SSL session messages. The “message type” field of the message header is 2 bytes long and contains the type code for the particular SSL session message being transmitted. The message type codes are predefined values which identify a particular SSL session message being transmitted. Each of the SSL session message types will be described in detail in the following sections of this specification. The “length” field of the message header is 2 bytes long and indicates the length of the entire message, including the header. Preferably, the minimum length of a single SSL session message is 16 bytes. Preferably, the message header always has a length of 8 bytes.

The message payload portion of the SSL session message contains “message type” specific parameters and/or data. These parameters and data will be described later in detail below.

A first SSL session message type is the “User Login And Channel Selection” message type. This message is used for user login and channel selection. Immediately after video session protocol SSL connection establishment, this message is the first message received by the appliance 11 from a client 10. Appliance 11 will ignore all other messages until a successful login and channel selection is performed. Appliance 11 will respond to the user login and channel selection message with a user login status message.

Two types of channel selections are possible with the user login and channel selection message. The channels indicate the hardware or electrical path through the appliance for a session's video. A finite number of video channels are available because each video channel requires some dedicated hardware for the A-to-D conversion. In the first type, the port number and cascaded port number fields are used to select channels. In the second type, the target device ID and cascaded port number fields are used to select channels.

The message payload in the User Login and Channel Selection message type includes the following fields: (1) user name length, (2) user name, (3) user password length, (4) user password, (5) ID, (6) Port Number, (7) Cascaded Port Number, and (8) client random. Each of those fields will be described below.

A “client random” field of this message contains a random number that the client will use later when establishing a TCP video connection. This number, in conjunction with the appliance random number, returned by the user login status message, is used to authenticate the TCP video connection. The TCP video connection is authenticated via the video session connect message.

The “user login and channel selection” message has a “user name length” field which is 1-byte long. The “user name length” field is the number of characters in the user name string. The “user name” field is 16×6 bytes long. The “user name” field is the name of the user attempting to login. This field is a UTF-8 encoded string. Six bytes are reserved for each of the 16 possible characters. For the English language where ASCII text codes are used, no more than 16 bytes would be required.

The “user password length” field is 1-byte long and identifies the number of characters in the user password string.

The “user password” field is 16×6 bytes long. The “user password” field is the password of the user attempting to login. This field is a UTF-8 encoded string. Six bytes are reserved for each of the 16 possible characters. For the English language, where ASCII text codes are used, no more than 16 bytes will be required.

The “ID” field is 8 bytes long and indicates the packed hex digits of the target device ID. Eight bytes can hold 16 digits.

The “port number” field is 1-byte long. If the “port number” field contains a non-zero value, then the type of channel selection will be port number and cascaded port number. If, however, the “port number” field is zero, channel selection will be by target device ID and cascaded port number.

The next field in the “user login and channel selection” message is the “cascaded port number” which is 1-byte long. The “cascaded port number” field should be non-zero to select a cascaded port ranging from 1-24 in preferred embodiment.

The next field is the “client random” field which is 4 bytes long. This field contains a random number used by the appliance for authentication of the TCP video connection.

The next type of message is the “user login and channel selection with pre-emption” message. This message is used for user login and channel selection when the desired channel may already be in use. Assuming that the requesting user has sufficient access privileges, this message will pre-empt the existing user. The format, fields, lengths, etc. of the user login and channel selection with pre-emption message are the same as those for the user login and channel selection message described earlier.

The next group of message types is the “keyboard/mouse message” group. This message group is used to transmit keyboard and mouse data or control commands to the appliance. This message group includes a number of message payload types, including: (1) keyboard data, (2) mouse data, (3) mouse origin, (4) mouse reset, (5) request keyboard LED status, (6) mouse adjust, (7) mouse enable, (8) set current scan code, and (9) focus control. Each of those will now be described.

The “keyboard data” message is used to transmit keyboard scan codes to the target device (i.e. the target server). One USB scan code is transmitted for each keyboard data message. Keyboard scan codes are from the USB keyboard/keypad page 0X07 defined and described further in the USB HID Usage Tables, version 1.11, Section 10, published by www.usb.org

(http://www.usb.org/developers/devclass_docs/Hut1_{—}11.pdf).

Because the USB codes do not define make and break, the “make break” field identifies whether the particular keyboard code is a key make or a key break. A “1” indicates that a subsequent code is a key break. A “0” code indicates that the subsequent code is a key make. USB scan codes are defined as 16-byte values. The message payload portion of the keyboard data message has four fields. The first field is 1-byte long and is preferably unused. The second field is the “make break” field (1-byte). The “scan code” field is 2 bytes long and includes the USB key codes. The values 0X04-0XE7 are valid USB key codes. The final four bytes of the data message payload are preferably unused.

The next message type is the “mouse data” message. The “mouse data” message is used to transmit mouse position and button status to the target device (i.e. a server). The “mouse data” message payload has four fields: the “mouse status” field (2 bytes); the “mouse X position” field (2 bytes); the “mouse Y position” (2 bytes); and the “wheel delta field” (2 bytes).

In the “mouse status” field, bit 0 is used to indicate whether the left button is pressed. Byte 1 indicates whether the right mouse button is pressed. Bit 2 indicates whether the middle button of the mouse is pressed. Bit 3 indicates if a fourth mouse button is pressed and bit 4 indicates if a fifth mouse button is pressed. Preferably, bits 5-15 of the mouse status field are unused.

The “mouse X position” field indicates the unsigned offset from the top left origin of the video screen. The “mouse Y position” field indicates the unsigned offset from the top left origin of the video screen. The “wheel delta field” is assigned a value indicating the amount of wheel movement.

The next message type is the “mouse origin” message type. The “mouse origin” message moves the target device cursor to the top left position of its video display. This message is used to align the client mouse cursor with the target device mouse cursor. The target device's mouse interface receives a large mouse movement sufficient to force its mouse cursor to the origin. The result is that the target device mouse cursor is then at a known location of (0,0).

The message payload portion of the “mouse origin” message is preferably unused.

The next message type is the “mouse reset” message. The “mouse reset” message causes a code to be transmitted to the target system indicating that the mouse has just “powered on” and has performed its self test. For targets that use Microsoft Windows, for example, the mouse reset message causes Windows to re-initialize its mouse input interface. The message payload portion of the “mouse reset” message is also preferably unused.

The next message is the “request keyboard LED status” message. This message causes the digital video appliance to report the current keyboard light status to the client. This message is used primarily to initialize the client's keyboard to reflect the state of the target device's interface. The appliance response to this message with a keyboard LED status message to the client. The message payload portion of this message is also preferably unused.

The “mouse adjusts message type” message adjusts the target device's mouse cursor position by the amount of the adjustment specified in the payload. A “mouse adjust message” payload contains a signed “X adjustment” field (2 bytes) and a signed “Y adjustment field” (2 bytes). The remaining four bytes are preferably unused. The “X adjustment” field is assigned value indicating the amount of adjustment to be made in the X (i.e. horizontal) direction. The “Y adjustment” field is assigned value indicating the amount of adjustment to be made in the Y direction (i.e. vertical direction).

The “mouse enable” message type enables the emulated mouse at the target device interface. This message is primarily used when the mouse interface cable has been hot-plugged. The mouse emulation, by default, is disabled when the cable is hot-plugged. If the target device is not able to reconfigure the mouse interface when hot-plugged, this can be used to recover the mouse interface. The client work station, however, needs to know if a target device's mouse driver was in Intellimouse-wheel mode prior to hot-plugging so that the correct form of this command can be used.

The message payload portion of the “mouse enable” message contains a “wheel enable” field (1-byte). The remaining seven bytes of this message payload are preferably unused. A “wheel enable” field value of zero indicates that the mouse does not have a wheel. A value of 1 indicates that this mouse has a wheel.

The “set current scan code” message type forces the digital video appliances keyboard emulating to begin using a specified scan code set for keyboard transmissions to the target device. This message is used primarily when hot-plugging the keyboard interface into a target device. In cases where the target device does not reconfigure its keyboard interface when hot-plugged, this message can be used to recover operation of the keyboard interface. Scan code set 2 is the default when a keyboard interface is hot-plugged. If the target device was operating in either scan code set 1 or scan code set 3, this message may be useful.

The message payload of the “set current scan code” message contains a “function” field which is 1-byte long. A “function” field value of 1 means that the digital video appliance should set the target device keyboard interface to scan code set 1. A “function” field value of 2 indicates that the target device keyboard interface should be set to code set 2. A “function” field value of 3 indicates that the target device keyboard interface should be set to scan code set 3. The remaining 7 bytes of the message payload are preferably unused.

The “focus control” message is used to inform the digital video appliance when the selected target device is “in focus” or “out of focus” on the client display. When video focus is lost, the appliance will transmit outstanding key code break sequences to the target device. (Client KVM sessions are determined to be in focus or out of focus depending on whether the title bar of the client window is gray or blue (i.e. the currently active window). The client software tells the applicance when each KVM session is in focus or out of focus.

The message payload portion of the “focus control” message contains a “focus” field (1-byte) that indicates whether the selected target device is in focus or out of focus. A value of zero indicates that the device is out of focus. A value of 1 indicates that the device is in focus. The remaining 7 bytes of the message payload are preferably unused.

The next message group is the “video control” message group. The “video control” message group is used to access/control the video sub-system of the digital video appliance. It can include one of the following kinds of message payloads, each of which is described below: (1) request video setup data, (2) full screen refresh, (3) set display area, (4) get input resolution, (5) set scale mode, (6) set noise threshold, (7) auto-adjust video a/d system, (8) test pattern control, (9) video a/d, width adjustment, (10) video a/d, fine adjustment, (11) video a/d vertical position, (12) video a/d, horizontal position, (13) video a/d, set brightness, (14) video a/d, set contrast, (15) video enable, and (16) set priority threshold.

The “request video setup data” message is used to request the current video configuration of the digital video appliance. The appliance responds to the client with the video setup data message. The message payload fields are preferably unused in the request video setup data message.

The “full screen refresh” message causes the appliance to generate a full screen refresh consisting of all possible digital video blocks via the TCP video connection. The message payload of the “full screen refresh” message is preferably unused.

The “set display area” message commands the appliance to set the video output display resolution to the given values. When this command is implemented, video output is enabled.

The message payload of the “set display area” message contains an “X resolution” field (2 bytes) and a “Y resolution” field (2 bytes). The “X resolution” field specifies the resolution of the video display output in the X direction. The “Y resolution” field specifies the resolution of the video display output in the Y direction. The remaining 4 bytes of the message payload are preferably unused.

The “get input resolution” message queries the digital video appliance for the currently selected target devices input resolution. The appliance responds to the client with the input resolution message. The message payload of the “get input resolution” message is preferably unused.

The “set scale mode 1:1” message commands the appliance to set the video scaling to 1:1 mode. If the input display is larger than 1,024×768, the input is scaled down to 1,024×768. The appliance responds to the client with two messages: the input resolution message and the display resolution message. The message payload of the “set scale mode 1:1” message is preferably unused.

The “set noise threshold” message is used to adjust the video difference engine noise threshold. To determine the current setting of the noise threshold, the client can transmit the request video setup data message to the digital video appliance. The “request video setup data” message is used to request the current video configuration. The appliance responds to the client with the message “Video Setup Data.”

A message payload of the “set noise threshold” message contains a “noise” field (2 bytes). This “noise” field specifies the noise threshold to be used by the digital video appliance to adjust the video difference engine noise threshold. No video blocks with fewer than this number of pixel differences will be transmitted. Preferably, values greater than 192 will prevent block updates. The remaining 6 bytes of the message payload are preferably unused.

The “auto-adjust video A/D system” message commands the video digitizer sub-system to auto-adjust itself. The message payload of this message is preferably unused.

The “test pattern control” message controls the video test pattern produced by the video digitizer sub-system. The message payload contains a “control” field (1-byte). A zero value instructs the digital video appliance to disable a test pattern. A value of 1 instructs the appliance to enable the test pattern. The remaining 7 bytes of the message payload are preferably unused.

The “video A/D width adjust” message controls the video width of the digitized video signal from the digital video appliance. To determine the current width setting, the client should transmit the “request video setup data” message to the appliance.

The message payload of the “video A/D width adjust” message contains a “width” field (2 bytes). The “width” field value sets the horizontal sampling frequency (width) of the digital video appliance. This number is relative to the horizontal frequency and the auto-detection logic of the digital video appliance. The range of valid frequency codes preferably are from 0-4,095. The remaining 6 bytes of the message payload are preferably unused.

The “video A/D, fine adjust” message controls the video by fine tuning the A-D conversion of the analog video signal from the target device. To determine the current fine setting, a client should send the request video setup data message to a digital video appliance.

The message payload of the “video A/D, fine adjust” message contains a field called the “fine” field (2 bytes). The value of this field sets the phase of the input signal which is sampled during the A/D process (PFT or fine tune). The range of the phase value is from 0-255, however, the value is internally divided by 8 so that the usable values are 0, 8, 16 . . . , 240. The remaining six bytes of the message payload are preferably unused.

The “video A/D, vertical position” message adjusts the vertical position of the digitized video signal. A client workstation can use the “request video setup data” message to determine the current vertical position setting in the digital video appliance.

The message payload of the “video A/D, vertical position” message includes a “vertical” field (2). This “vertical” field specifies the vertical position in lines of the digitized video signal. By adjusting the value in the “vertical” field, this command adjusts the vertical position in lines of the video signal. The range in values is preferably from 0-4,095. The remaining 6 bytes of the message payload are preferably unused.

The “video A/D, horizontal position” message sets the horizontal position of the digitized video signal. The client can determine the current horizontal position using the “request video setup data” message. The message payload contains a “horizontal” field (2 bytes). This field includes a value corresponding to the desired horizontal position in pixels. The range of values is preferably from 0-4,095. The remaining 6 bytes of the message payload are preferably unused.

The “video A/D, set brightness” message is used to set the desires brightness of the digitized video signal. A client can determine the current brightness setting using the “request video setup data” message.

The message payload of the “video A/D, set brightness” message contains a “brightness” field (2 bytes). This field contains a value which sets the desired brightness (black level) of the display. The brightness value is a number ranging from 0-255, with 255 being the brightest. The remaining 6 bytes of the message payload are preferably unused.

The message payload for the “video A/D, set contrast” message controls the video contrast adjust. The current contrast setting can be determined using the “request video setup data” message. The “video a/d, set contrast” message contains a “contrast” field of 2 bytes, with a value that adjust the contrast (white level) of the display. The contrast value is a number from 0 to 255, with 255 being the greatest contrast. The remaining 6 bytes of the message payload are preferably unused.

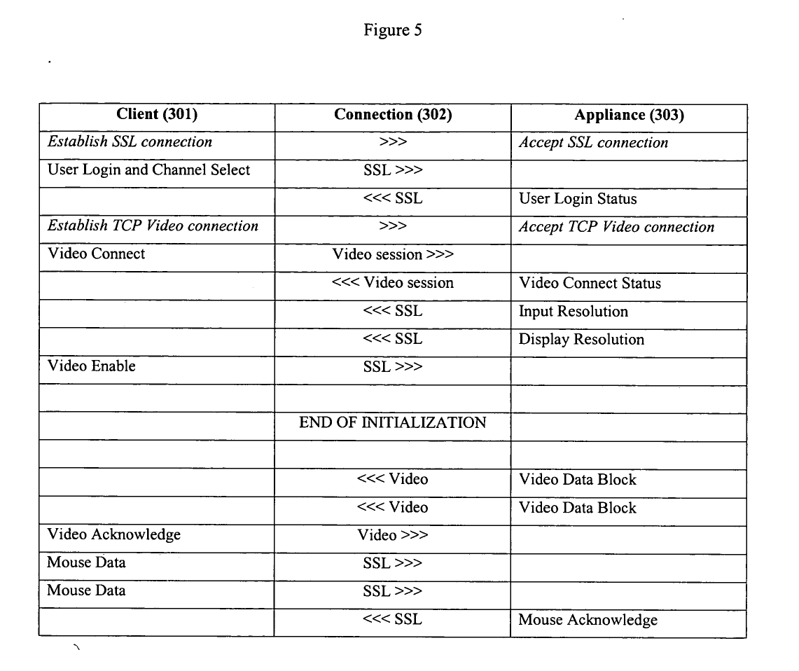

The message payload for the “video enable” message controls the transmission of digitized video. It is typically used only at the beginning of a KVM session, particularly during the initial session dialogue described below with respect to FIG. 5. The “video enable” message contains a “control” field of 1-byte, with a value of 0 for disable video transmission and 1 for enable video transmission. The remaining 7 bytes of the message payload are preferably unused.

The message payload for the “set priority threshold” message is used to adjust the video difference engine priority threshold. The current contrast setting can be determined using the “request video setup data” message. Video blocks with more differences than the number in this message payload will be transmitted with high priority. A priority threshold should be set to a higher value than the noise threshold. The remaining 6 bytes of the message payload are preferably unused.

The next group of messages is the “session control” messages. There are three types of session control messages, which are described below: (1) heartbeat, (2) timeout disable, and (3) set video transmit limit.

The “heartbeat” message is sent periodically from the client to the appliance when the client has no other useful message to send. If the appliance does not receive any messages from the client for a predefined period of time (e.g., one minute), the appliance will assume the client connection is no longer active and will terminate the KVM session. This “heartbeat” message is used to insure that lost network connections and broken clients (client workstations that are not working correctly) do not permanently consume KVM connections because it is possible for a client system to maintain a TCP session with the appliance and still not be able to function as a KVM client. Preferably, a client sends a “heartbeat” message once every 10 seconds when needed. The remaining 8 bytes of the message are preferably unused.

The second “session control” message is the “time out disable” message. A “time out disable” message disables the session heartbeat timeout for the current KVM session. This message can be used, for example, when diagnostic exercises are conducted between the client and the digital video appliance. This message is not used in normal operation. The effect of this command is to permit connections between the client and the digital video appliance to remain active for an indefinite period of time even though no communication occurs over that connection. The message payload portion of the “time out disable” message is preferably unused.

The third “session control” message is the “set video transmit limit” message. The “set video transmit limit” message adjusts the flow management of transmitted video blocks from appliance to client. This message selects the transmit limit, the number of video blocks the appliance will transmit without acknowledgment from the client. When transmitting video blocks, the appliance will only send a finite number of video blocks before performing a self-imposed flow control. When the transmit limit is reached, transmission of the video stops. The client must acknowledge each video block received in order to continue to receive additional video blocks. To maintain a steady stream of video, the client must acknowledge the video before the transmit limit is reached.

Use of a transmit limit is desirable to limit the amount of video data that is buffered in the network FIFO between the appliance and the client. This limit helps to insure that video is reasonably fresh when it arrives at the client.

Setting the transmit limit to a value below the default is preferably appropriate only when the network connection between the appliance and the client is known to have a lower band width than a 100 base/T local area network.

The message payload portion of the “set video transmit limit” message contains a “transmit limit” field (1-byte). The “transmit limit” field contains values preferably in the range from 8-96. The remaining 7 bytes of the message payloads are preferably unused.

The protocol also provides for the transmission of commands to a video sub-system located in the digital video appliance. In a preferred embodiment, the video sub-system of the digital video appliance may include a specialized video processor, such as a Pearl processor made by Pixelvision/Avocent. The particular commands that can be utilized by the processor in the video sub-system are defined by the specification sheet or data sheet for the particular processor. In a preferred embodiment, the commands are the same as the commands for the Pearl processor available from Pixelvision/Avocent

In the present protocol, the “video sub-system commands” message is used to send diagnostic commands to the video sub-system from a client performing diagnostic analysis. This message is not used in normal operation.

The message payload of the “video sub-system commands” message includes a “start of message” field (1-byte), a “destination” field (1-byte), a “message length” field (1-byte), a number of “data” fields (of 1 byte per field and N number of fields), an “end of message” field (1-byte), and an optional “padding field” (m bytes).

The “start of message” field contains the start of message code. This is a predefined value indicating the start of message.

The “destination” field identifies the destination of the message. In the preferred embodiment, this is a Pearl processor located in the video sub-system of the digital video appliance.

The “message length” field contains a value ranging from 0-255 that indicates the length of the message data that follows.

The “data” fields contain the data associated with the message command.

The “end of message” field contains the end of message value indicating the end of the foregoing message.

The “padding” field contains optional data which is necessary to make the packet at least 16 bytes long. Preferably, the padding has a zero value.

That completes the SSl Session Message Types from the client to the appliance. Now, the SSL Session Message Types from the appliance to the client will be described.

The first group of SSL session message types from the appliance to client are the “keyboard/mouse response” messages. The “keyboard/mouse response” message group is used to transport keyboard and mouse related information from the appliance to the client. The group includes two message payload types, including: (1) keyboard LED status and (2) mouse acknowledge.

The “keyboard LED status” message is used to transport keyboard LED status to the client. This message occurs when the keyboard light status of a target device changes or when requested by the client via the “request keyboard LED status” message.

The message payload portion of the “keyboard LED status” message includes an “LED status” field (1-byte). Bit 0 of the “LED status” field corresponds to the scroll lock indicator. Bit 1 corresponds to the numbers lock indicator. Bit 3 corresponds to the caps lock indicator. Bit 4 corresponds to the kana lock indicator. The 7 remaining bits in the message payload are preferably unused.

A “mouse acknowledge” message is used to pace the transmission of mouse messages from the client to the digital video appliance. This message insures good performance without overrunning the appliance.

For each mouse message received by the appliance, the appliance must acknowledge its reception. Each mouse message acknowledged permits a client to transmit another mouse message. The client will generate and transmit no more than 50 mouse messages without acknowledgment from the appliance. The client must transmit mouse messages at a frequency of 50 HZ or less. The appliance can acknowledge zero or more mouse messages with one mouse acknowledge message.

The appliance will acknowledge mouse messages when one of the following conditions exist: (1) when the number of unacknowledged mouse messages is greater than 25, the appliance will send the “mouse acknowledge” message with the number of mouse messages unacknowledged; or (2) when 250 milliseconds has passed and there are unacknowledged mouse messages remaining, the appliance will send the “mouse acknowledge” message with the number of mouse messages unacknowledged.

A message payload portion of the “mouse acknowledge” message contains an “acknowledge count” field (1-byte). The “acknowledge count” field includes a value identifying the number of mouse messages which are being acknowledged. This value preferably ranges from 0-50 messages. The remaining 7 bytes of the message payload are preferably unused.

The next message group in the SSL session message types (appliance to client) is the “video responses” message group. The “video responses” message group is used to transport video response data to the client. The group includes a number of message payload types including: (1) input resolution, (2) display resolution, and (3) video setup data.

The “input resolution” message is used to transport video input resolution to the client. The message payload portion of the “input resolution” message contains an “X dimension” field (2 bytes) and a “Y dimension” field (2 bytes). The “X dimension” field contains the input resolution of the target device video in the X direction (i.e., the horizontal direction). The “Y dimension” field contains the input resolution from the target device in the Y direction (i.e., vertical direction). The remaining 4 bytes of the message payload are preferably unused.

The “display resolution” message is used to transport video output display resolution to the client. The message payload contains an “X dimension” field (2 bytes) and a “Y dimension” field (2 bytes). The “X dimension” field contains the output display resolution in the X direction. The “Y dimension” field contains the output display resolution in the Y direction. The output resolution is what is generated by the Pearl processor, made by Pixelvision/Avocent, for the purpose of transmission over the network. Additionally, the input resolution is what the Pearl processor receives from the target system. The remaining 4 bytes of the message payload are preferably unused.

The “video setup data” message is used to transport the current video digitizer configuration to the client. The message payload of the “video setup data” message contains a “brightness” field (2 bytes), a “contrast” field (2 bytes), a “horizontal position” field (2 bytes), a “vertical position” field (2 bytes), a “width” (RGB frequency) field (2 bytes), a “fine” (RGB phase) field (2 bytes), an “RGB horizontal resolution” field (2 bytes), an “RGB vertical resolution” field (2 bytes), a “noise threshold” field (2 bytes), and a “priority threshold” field (2 bytes). The remaining 4 bytes of the message payload are preferably unused.

The “brightness” field contains a value that is the current brightness (black level) of the display. Preferably, the brightness value is a number from 0-255, with 255 brightest.

The “contrast” field contains a value that is the current contrast (white level) of the display. The contrast value is a number preferably ranging from 0-255, with 255 being the greatest contrast.

The “horizontal position” field contains a value ranging preferably from 0-4,095 and indicates the horizontal position of the pixel.

The “vertical position” field contains a value ranging from 0-4,095 and indicates the vertical position of the pixel.

A “width” field contains a value that is the current horizontal sampling frequency (width). This number is relative to the horizontal frequency in the auto-detection logic within the digital video appliance. The range of valid frequency codes are from 0-4,095.

The “fine” field contains a value that is the current phase of the input sample (PFT or fine tune). The range of the phase value is preferably from 0-255. However, the value is internally divided (within the digital video appliance) by 8 so that the usable values are 0, 8, 16, . . 240.

The “RGB horizontal resolution” field contains a value corresponding to the horizontal input resolution of the RGB analog video signal received from the target device.

The “RGB vertical resolution” field contains a value corresponding to the vertical input resolution of the analog RGB video signal received from the target device

The “noise threshold” field contains a value preferably ranging from 0-255 corresponding to the noise threshold used by the video sub-system to digitize the analog video received from the target device. In an exemplary embodiment, the default value for the noise threshold is 6

A “priority threshold” field contains a value ranging preferably from 0-255 indicating the priority threshold used by the video difference engine within the video sub-system of the digital video appliance.

The next message group of the SSL session message types (appliance to client) is the “session status” message group. The “session status” message group is used to convey session-related information to the client. The group includes two message types, (1) user login status, and (2) user disconnect pending.

The “user login status” message is sent from the appliance to the user in response to the “user login and channel selection” messages. The message payload of the “user login status” message contains a “login status” field (1-byte), an “appliance random” field (4 bytes), a “user name length” field (1-byte), and a “user name” field (16×6 bytes). The 3 bytes between the “login status” field and the “appliance random” field are preferably unused.

The “login status” field indicates the success or failure of the user login and channel selection. A zero value indicates success. A value of 1 indicates an invalid user name. A value of 2 indicates an invalid password. A value of 3 indicates channel access is denied. A value of 4 indicates a channel in use. A value of 5 indicates the desired channel was not found. A value of 6 indicates the desired channel is in use and the requesting user has rights to preempt. A value of 7 indicates that the desired channel is in use by a local user.

The “appliance random” field contains a random number to be used by the client when making the TCP video connection in order for the TCP video connection to be authenticated.

The “user name length” field contains a value indicating the number of characters in the user name string.

The “user name” field contains the user's name that is using the channel when a channel selection fails because the channel is currently in use. If the local port is using the channel, the user's name is “local port.” This field is preferably a UTF-8 encoded string. Six bytes are reserved for each of the 16 possible characters. For the English language where ASCII text codes are used, no more than 16 bytes will be required.

The “user disconnect pending” message is sent from the appliance to the user immediately before the user session is forcibly disconnected by an administrator. This message allows the user software to display a printed message to the user indicating that termination is eminent. The message payload portion of the “user disconnect pending” message contains a disconnect reason field (1-byte). A zero value indicates an administrator disconnect. A value of 1 indicates a session idle time out has been exceeded. A value of 2 indicates that an appliance reboot is pending. A value of 3 indicates that a DSRIQ upgrade is pending. A value of 4 indicates that the current channel has been preempted by the local user. The remaining 7 bytes of the message payload are preferably unused.

The last type of SSL session message types (appliance to client) is the “video sub-system response” message. The “video sub-system response” message is used to transport video sub-system processor responses to a diagnostic client. In the preferred embodiment, a video sub-system processor is a Pearl processor. Because this message relates to diagnostic testing, this message is not used in normal operation.

The message payload of the “video sub-system response” message contains a “start of message” field (1-byte), a “destination” field (1-byte), a “message length” field (1-byte), a series of “data” fields (1-n bytes), and an “end of message” field (1-byte).

The “start of message” field contains the predefined start of message code.

The “destination” field contains a value generated by the video sub-system processor indicating which video sub-system processor is sending the present “video sub-system response” message.

The “data” fields contain the various bytes of the messages being sent by the video sub-system processor. In the preferred embodiment, the messages from the video sub-system processor are defined in the data sheet or specification sheet published for the video sub-system processor, such as the Pearl processor by Pixelvision/Avocent.

The “end of message” field contains a redefined end of message value.

That concludes the SSL Session Message Types communicated from the appliance to the client.

The video session protocol portion of the present protocol is implemented using a “video session” message. Each video session protocol “video session” message is made up of a header and a payload. Payloads immediately follow the header. Message lengths are always a minimum of 16 bytes. All multi-byte parameters are transmitted in network byte order.

The “message” header of a “video session” message contains an “undefined” field of 4 bytes, a “digitizer port” field of 1-byte, a message type field of 1-byte, and a length field of 2 bytes. The “digitizer port” field is the index of the video digitizer from which this message originated. This field is only valid for messages transmitted from the appliance to the client.

The “message type” field contains the predefined values identifying which message type is being sent.

The “length” field indicates the length of the entire message. Preferably, the minimum length is 16 bytes. The message header preferably has a length of 8 bytes at all times.

The message payload contains the “message type” specific parameters and/or data.

The first group of message types falling under the video session protocol describe message types transmitted from the appliance to the client. There are two such message types, the first of which is the “video data block” message. The “video data block” message is used to transport individual video data blocks to the client application.

The message payload portion of the “video data block” message contains a “user programmable” field (4 bytes), a “cursor Y axis” field (2 bytes), a “cursor X axis” field (2 bytes), a “block Y position” field (2 bytes), a “block X position” field (2 bytes), and a “compressed pixel data sequence” field (n bytes).

The “user programmable” field indicates that the field is not used for normal operation and can contain later-defined information. In one exemplary embodiment, “the user programmable” field contains a recognizable pattern for network monitoring. Thus, in that embodiment, the video message blocks can be easily spotted for development purposes.

The “block Y position” field indicates the pixel position of the top/left pixel of the video block. This position aligns to 16-pixel boundaries.

The “block X position” field indicates the pixel position of the top/left pixel of the video block. This position aligns to 64-pixel boundaries.

The “compressed pixel data sequence” field contains the pixel data which is generated in multiples of 4 bytes. The format of that pixel data will now be described.

The video block pixel data is a sequence of bytes containing either pixel information or run-length compression headers. This stream of bytes is filled into 32-byte words with the first byte occupying the most significant 8 bytes of a word and then filling towards the lower significant bytes. At the end of a video block, the 32-byte word currently being filled will be completed with random data.

One video block consists of 16 line sequences with each line sequence describing 64 pixels. All pixels are processed in pairs, so each line is treated as 32 double-pixels. Compression is achieved by detected repeated sequences of double-pixels, partitioning a line (64 pixels, 32 double-pixels) into repeated and incompressible segments and and replacing the repeated double-pixel sequences with a repetition count and a single instance of these two pixels. Double-pixel sequences are only recognized on an even pixel boundary. Pixel sequences do not repeat in this type of sequence and are preceded by a compression header indicating their length followed by the pixel-sequence directly.

The compression header consists of a single byte with the following byte-filed definitions:

Byte 7: compression indicator. A “1” indicates that the following double-pixel was detected in a repeated pattern. A “0” is indicated if a sequence of uncompressed double-pixels follows.

Bytes 6+5: Not used. Set to zero.

Bytes 4−0: The number of double-pixels in this segment.

Each line of the video display will be treated separately, so no segment can contain more than 32 double-pixels and the double-pixel counts of all segments belonging to one line will add up to 32. At the end of the last segment of a line, an incomplete word containing the last byte belonging to this segment will not be filled with random data, but the first byte of the first segment of the following line will be put into the same word. An incomplete word will be filled only at the end of a video block.

The following are provided as examples of the pixel data format and all numbers are in hexadecimal form. As a first example, a pixel sequence 00 05 23 05 23 00 5c 44 will not be recognized as compressible since, after partitioning it into double-pixels, there is no repetition. Thus, the sequence will then be output as 04 00 05 23 05 23 00 5c 44.

As a second example, the sequence 59 3f 77 3f 77 3f 77 3f 77 3f 77 3f 23 99 23 99 23 99 44 13 44 06 will be output as: 01 59 3f 85 77 3f 83 23 99 02 44 13 44 06.

Using this format, each line can be reduced to a single compressed segment (3 bytes) in the best case, or remain a single, uncompressed sequence of 64 pixels (65 bytes). Therefore, the length of the video pixel data can range from 48-1,040 bytes.

The next message in the group of message types (appliance to client) is the “video connect status” message. The “video connect status” message is used to acknowledge successful video connect messages. Upon receipt of this message, the client should assume that both SSL and TCP video sessions have been successfully authenticated.

The message payload of the “video connect status” message contains a “connect status” field (1-byte). If the “connect status” field is set to zero, this indicates that both the SSL and TCP video sessions have been successfully connected. The remaining 7 bytes of the message payload are preferably unused.

The next type of video session messages are the message types transmitted from the client to the appliance. The first such message is the “video acknowledge” message. The “video acknowledge” message is used to pace the transmission of video blocks from the digital video appliance to the client. This message insures good performance without over-running the client.

For each video block received by the client, the client must acknowledge its reception. Each video block acknowledged permits the appliance to transmit another video block. The appliance, by default, will generate and transmit no more than 96 video blocks without acknowledgment from the client. The transmit limit is adjustable. The client can acknowledge zero or more video blocks with one “video acknowledge” message.

Preferably, the client will acknowledge video blocks when one of the following conditions exist: (1) when the number of unacknowledged video blocks is greater than half the transmit limit (i.e., 96/2, by default), the client will send the “video acknowledge” message with the number of unacknowledged video blocks; or (2) when 250 milliseconds has passed and there are unacknowledged video blocks remaining, the client will send the “video acknowledge” message with the number of unacknowledged video blocks.

The message payload portion of the “video acknowledge” message contains an “acknowledge count” field (1-byte), a “client random” field, and “an appliance random” field. The “acknowledge count” field indicates the number of video blocks which are being acknowledged and preferably ranges from 0-96. The remaining 7 bytes of the message payload are preferably unused.

The video connect message is used to authenticate a TCP video session connections that are associated with video session protocol SSL sessions. The “video connect” message must be the first message received by the appliance on the TCP video session connection. If the random numbers given by the client are not correct, both the TCP session and the SSL session are terminated by the appliance.

The “client random” field of this message contains the same random number that the client transmitted to the appliance in the user login and channel selection message.

The “appliance random” field of this message contains the same random number that the appliance transmitted to the client in the user login status message.

The message payload portion of the “video connect” message contains a “client random” field (4 bytes) and an “appliance random” field (4 bytes). The “client random” field contains a value which is the random number given by the client during SSL session user login. The “appliance random” field contains the random number given by the appliance in response to the SSL session user login.

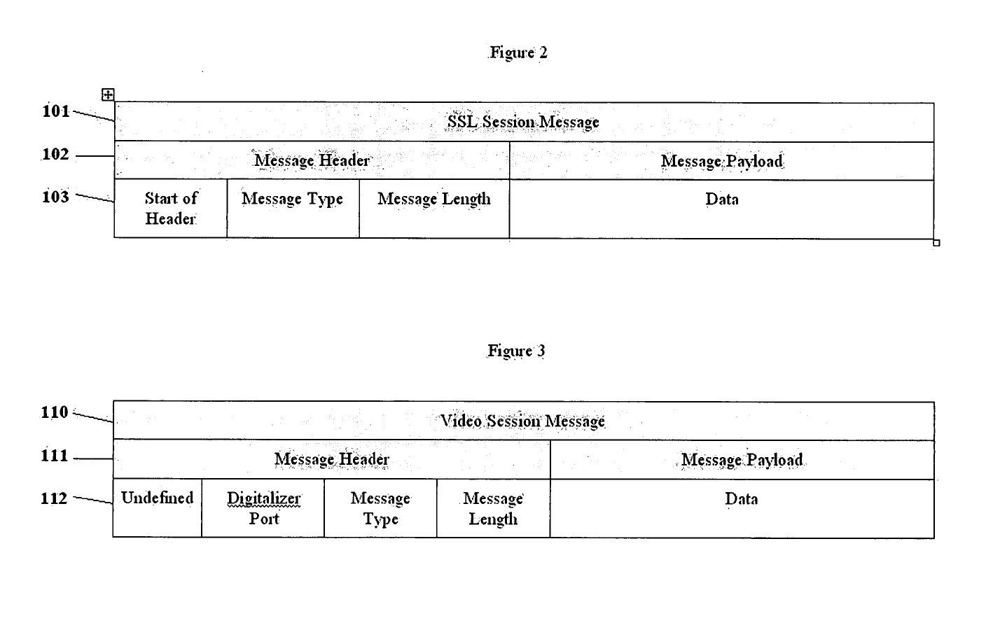

Referring to FIG. 3, row 110 identifies the exemplary message as a “video “session message. Row 111 shows that a “video session” message has two components comprised of a message header and a message payload. Row 112 indicates that the message header begins with an “undefined” field followed by a “digitizer port” field, a “message type” field, and a “message length” field. Row 112 also shows that the data corresponding to the message payload follows the last field of the message header.

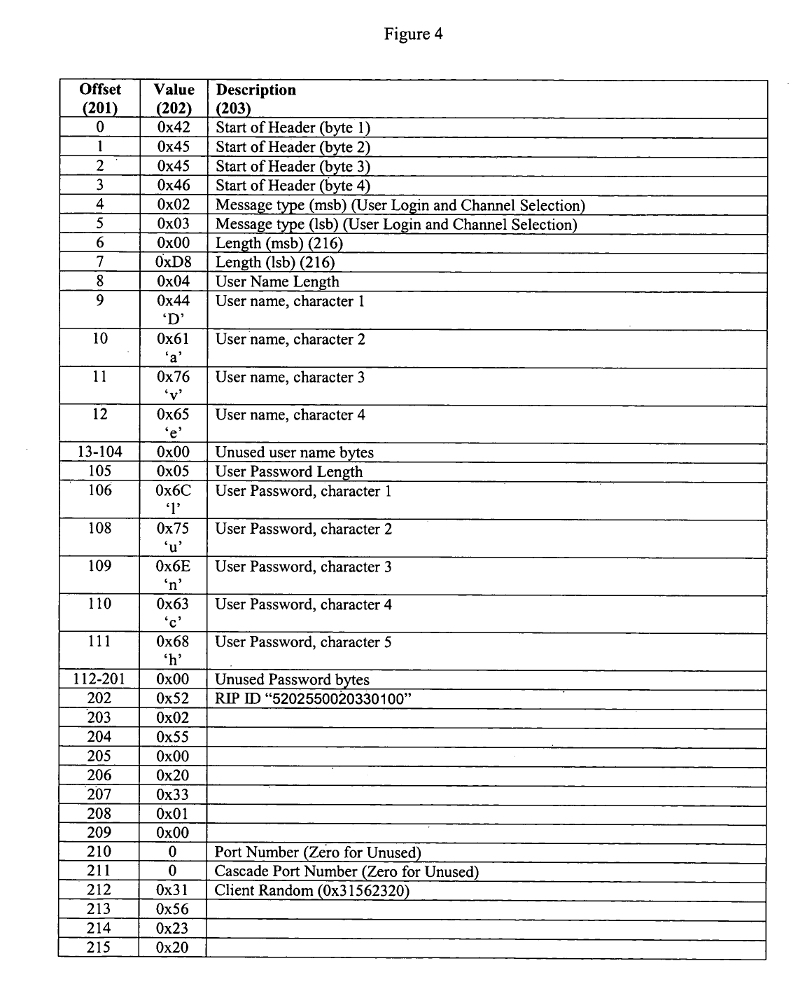

FIG. 4 shows a sample SSL session message. This sample message uses the “user login and channel selection” message as they message type. Column 201 shows the relative offset in bytes from the beginning of the message. Column 202 shows the actual hexadecimal value for each byte of the message. Column 203 provides the description of each byte in the message.

The first 4 bytes of the message are the “start of header” bytes. In this example, the “start of header” data has been chosen as having a hexadecimal value of 42 45 45 46. The “start of header” field is followed by the “message type” field. The “message type” field has two bytes. For the “user login and channel selection” message, the hexadecimal value corresponding to this message type has been assigned as hexadecimal 02 03. A “message length” field follows the “message type” field and also occupies 2 bytes. In this example, the length of the message in hexadecimal value is D8. The “user name length” field follows the “message length” field and has a value of 0x04. The “user name length” field begins the message payload portion of the “user login and channel selection” message.

Offset bytes 9-104 correspond to the “user name” field. In this example, the user name of “Dave” has been chosen.

Offset byte 105 corresponds to the user password length which has a hexadecimal value of 0x05. Offset bytes 106-201 correspond to the “user password” field. The user password is “LUNCH.” Offset bytes 202-209 correspond to the target device ID, where the target device ID can be a serial number that uniquely identifies each module. Offset byte 210 contains the port number. In this example, the port number is set to zero in order to select the destination by ID. Offset byte 211 contains the cascade port number. In this example, the cascade port number is set to zero because it is unused. Offset bytes 212-215 correspond to the client random field and contain the random number used by the appliance for authentication of the TCP video connection.

FIG. 5 illustrates the initial dialog that occurs between a client and a digital video appliance. In this example, the display resolution of the digital video appliance is accepted without change.

Column 301 shows the action and messages sent by the client. Column 302 shows the connection used and the direction that the messages or action occurred in. Column 303 shows the action taken by the appliance or the message is transmitted by the appliance. Initially, the client wishes to establish an SSL connection with the appliance. In order to do so, a client transmits a “user login and channel select” message across an SSL connection to the appliance. The appliance responds with a “user login status” message across the same SSL connection. In a next step, the client wishes to then establish a TCP video connection with the appliance. To do so, the client transmits a “video connect” message across the video session connection to the appliance. The appliance responds with a “video connect status” message to the client across the same video session connection. The appliance then transmits an “input resolution” message followed by a “display resolution” message across the SSL connection to the client. The client then transmits a “video enable” message to the appliance through the SSL connection. At that point, the initialization process has been completed. Thereafter, the appliance transmits one or more video data block messages across the video connection to the client. The client periodically acknowledges receipt of the video data blocks with a “video acknowledge” message. When the user inputs mouse data, the client transmits that mouse data in a “mouse data” message through the SSL connection to the appliance. The appliance acknowledges receipt of that data by transmitting a “mouse acknowledge” message through the SSL connection back to the client.

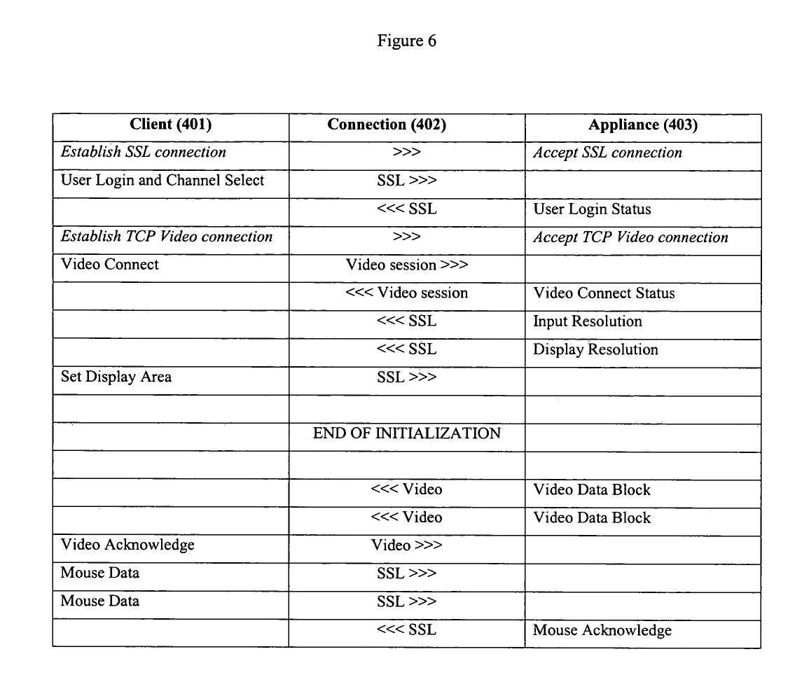

FIG. 6 illustrates a different example of the initial dialog that occurs between the client and a digital video appliance. In this example, the display resolution is adjusted before video transmission begins.

Column 401 shows the actions to be taken by the client and messages to be transmitted by the client. Column 402 shows the connection used for the transmission of the messages or action and the direction in which the messages or action occurs. Column 403 shows the actions taken by the appliance or messages transmitted by the appliance. Initially, the client wishes to establish an SSL connection with the appliance. To do so, the client transmits a “user login and channel select” message across the SSL connection to the appliance. The appliance responds with a “user login status” message also transmitted through the SSL connection. The client then wishes to establish a TCP video connection with the appliance. To do so, the client transmits a “video connect” message to the appliance through a video session connection. The appliance responds with a “video connect status” message also transmitted to the video session connection. The appliance then transmits an “input resolution” message and a “display resolution” message to the client through the SSL connection. The client then responds with a “set display area” message transmitted through the SSL connection. This ends the initialization of the connections between the client and the appliance. Following initialization, the appliance then transmits one or more video data block messages through the video connection to the client. The client periodically responds by transmitting a “video acknowledge” message again through the video connection to the appliance. Also, if a user enters mouse data at the client work station, the client transmits “mouse data” messages through the SSL connection to the appliance. The appliance periodically responds with a “mouse acknowledge” message also transmitted through the SSL connection.

Modifications and substitutions to the present invention made by one of ordinary skill in the art are considered to be within the scope of the present invention, which is not to be limited except by the claims which follow.

1. In a keyboard, video, mouse (KVM) system, a method of communicating between a client workstation and a server, comprising:
establishing a secure connection between the client workstation and a digital video appliance for data transmission to the server; and
establishing a non-secure connection between the client workstation and the digital video appliance for video transmission to the server.

2. The method as in claim 1 wherein the secure connection is a secure sockets layer (SSL) connection.

3. The method as in claim 2, wherein the SSL connection utilizes 16 bit messages.

4. The method as in claim 3, wherein the 16 bit messages comprise a message header indicating the start of the header, message type and length of the message as well as a message payload containing the message data.

5. The method as in claim 1, wherein all communications between the client workstation and the server take place over the SSL connection.

6. In a keyboard, video, mouse (KVM) system, a method of communicating between a client workstation and a server, comprising:
sending a SSL signal from the client workstation to a digital video appliance;
relaying the SSL signal from the digital video appliance to the server; and
receiving and processing the SSL signal at the server to establish a communication link between the server and the client workstation.

7. The method of claim 6, wherein video signals are transmitted from the client workstation to the server after establishing a secure communications connection.

8. A method of establishing a keyboard, video, mouse (KVM) session between a client workstation and a server, comprising:
establishing a secure sockets layer (SSL) connection between a digital video appliance and the server, and
establishing a non-secure TCP connection between the client workstation and a digital video appliance and between the digital video appliance and the server.

9. The method of claim 8, wherein the digital video appliance is a KVM switch.
